(19) United States
(12) Patent Application Publication
(10) Pub. No.: US 2005/0100038 A1
(43) Pub. Date: May 12, 2005

(54) Wireless communication method and apparatus for efficiently providing channel quality information to a Node-B downlink scheduler

(75) Inventors: Philip J. Pietraski, Huntington Station, NY (US); Gregory S. Sternberg, Great Neck, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 10/946,028

(22) Filed: Sep. 21, 2004

Related U.S. Application Data
(60) Provisional application No. 60/519,431, filed on Nov. 12, 2003.

(51) Int. Cl. H04L 12/56

(52) U.S. Cl. 370/437

(57) ABSTRACT

A method and apparatus for obtaining channel quality estimates for a downlink scheduler located in a Node-B which communicates with a plurality of wireless transmit/receive units (WTRUs). The Node-B signals a scheduled WTRU, via a high speed shared control channel (HS-SCCH) carrying valid transport format resource combination (TFRC) information, indicating that a high speed downlink shared channel (HS-DSCH) transmission will be arriving. The Node-B also indicates the upcoming arrival of the HS-DSCH transmission by signaling at least one non-scheduled WTRU via a HS-SCCH carrying invalid TFRC information. The Node-B transmits the HS-DSCH transmission to the scheduled WTRU. The non-scheduled WTRU monitors a subset of the HS-DSCH transmission and, when invalid TFRC information is detected, determines a CQI without decoding HS-DSCH data. Otherwise, the results of cyclic redundancy check (CRC), always a non-acknowledgement (NACK) message, is signaled along with the CQI to the Node-B.

### CROSS REFERENCE TO RELATED APPLICATION

This application claims priority from U.S. Provisional Patent Application Ser. No. 60/519,431, filed Nov. 11, 2003, which is incorporated by reference as if fully set forth herein.

### FIELD OF INVENTION

The present invention relates to wireless communication systems. More particularly, the present invention is related to a wireless communication method and apparatus for obtaining current channel quality estimates to support the scheduling of data on high speed channels.

### BACKGROUND

In certain prior art wireless communication systems, fast scheduling of radio resources for wireless transmit/receive units (WTRUs), i.e., mobile units, is used to increase system throughput and capacity. When several WTRUs within a cell have data to be downloaded from the Node-B, an intelligent fast scheduler in the Node-B will apply a set of rules that will tend to schedule WTRUs during periods when better fading conditions exist for each of the WTRUs. Thus, the scheduler needs to have current estimates of the channel quality for each of WTRUs with data buffered for download. A modulation and coding controller is part of the scheduler in the Node-B. It decides the appropriate code rate and modulation type to be used with a packet transmission based on channel quality reports and resource constraints.

Scheduling refers to the assignment of radio resources among a plurality WTRUs. In fast scheduling, the Node-B will assign and re-assign resources at a rate that is fast enough to adapt to the changing channel conditions for all WTRUs requesting service based on the channel quality indicators (CQIs) available from different WTRUs.

For example, in a third generation partnership project (3GPP) system using a high speed data packet access (HSDPA) architecture, WTRUs report a CQI to the Node-B to facilitate adaptive modulation and coding (AMC) and fast scheduling.

In a frequency division duplex (FDD) system using HSDPA architecture, channel quality can be estimated from the common pilot channel (CPICH), and all WTRUs in the cell dedicated channel (DCH) state frequently report their CQI to the Node-B even when they are not actively receiving data.

In a time division duplex (TDD) system using HSDPA architecture, CQI reports are only generated after the reception of a high speed downlink shared channel (HS-DSCH). A HS-DSCH transmission is the transmission carrying the packet data. It will only be transmitted and received when the WTRU is scheduled according to a fast scheduler. The HS-DSCH is a packet-oriented shared channel and is therefore only scheduled for any particular WTRU in a discontinuous fashion.

The HSDPA service, and therefore the HS-DSCH, is inherently a downlink service whereby the Node-B transmits the HS-DSCH and the WTRU receives it. This presents two problems.

First, the modulation and coding controller will not have a current channel quality for the first HS-DSCH transmission. A CQI report is generated in response to a HS-DSCH transmission. Since there is no previous HS-DSCH for the first HS-DSCH, there can be no CQI to be used when configuring the first HS-DSCH. Since a CQI is valid for only a short time, (because the channel is continually changing), a HS-DSCH transmission will be considered a first transmission after a short interval, since the Node-B will have no current channel quality report. Depending on how frequently the WTRU is scheduled by the fast scheduler in the Node-B, the AMC procedure may be forced to work with CQI reports that are too old to be useful to compensate for multipath fading thereafter.

Second, since only scheduled WTRUs generate CQI reports, the fast scheduler cannot make decisions based on current CQI data from all WTRUs. This relegates the scheduler to operate as a round robin (RR) type scheduler. Both of these problems represent serious degradations for TDD-HSDPA. An improved solution for use in a TDD-HSDPA system is desired.

### SUMMARY

The present invention is related to a wireless communication method and apparatus that permits a WTRU operating in a TDD-HSDPA system to measure and report CQI to the Node-B without using any additional HS-DSCH resources. Such WTRUs may be configured to conserve power while polling CQIs. The apparatus may be a wireless communication system, a WTRU, a Node-B and/or an integrated circuit (IC). Channel quality estimates are performed and provided to a downlink scheduler located in a Node-B which communicates with a plurality of WTRUs.

The Node-B signals a scheduled WTRU, via a high speed shared control channel (HS-SCCH) carrying valid transport format resource combination (TFRC) information, indicating that a HS-DSCH transmission will be arriving. The Node-B also indicates the upcoming arrival of the HS-DSCH transmission by signaling at least one non-scheduled WTRU via a HS-SCCH carrying invalid TFRC information. The Node-B transmits the HS-DSCH transmission to the scheduled WTRU. The non-scheduled WTRU monitors a subset of the HS-DSCH transmission. The non-scheduled WTRU determines a CQI without attempting to decode HS-DSCH data when invalid TFRC information is detected. Otherwise, a cyclic redundancy check (CRC) is performed on the data, and the result of the CRC, always a non-acknowledgement (NACK) message, is signaled along with the CQI to the Node-B.

The downlink scheduler in the Node-B uses the CQIs to make intelligent fast scheduling and modulation and coding decisions. The non-scheduled WTRU transmits a NACK message or does not transmit (DTX) the ACK/NACK signal to the Node-B if invalid TFRC information is detected. The TFRC information is invalid if it does not carry information required to correctly decode the DSCH data.

### BRIEF DESCRIPTION OF THE DRAWINGS

A more detailed understanding of the invention may be had from the following description, given by way of example and to be understood in conjunction with the accompanying drawings wherein:

FIG. 1 is a wireless communication system operating in accordance with the present invention; and

FIG. 2 is a flowchart of a process including method steps for estimating channel quality in accordance with the present invention.

### DETAILED DESCRIPTION OF THE PREFERRED EMBODIMENT(S)

The present invention will be described with reference to the drawing figures wherein like numerals represent like elements throughout.

Hereafter, the terminology “WTRU” includes but is not limited to a user equipment (UE), a mobile station, a fixed or mobile subscriber unit, a pager, or any other type of device capable of operating in a wireless environment.

When referred to hereafter, the terminology “Node-B” includes but is not limited to a base station, a site controller, an access point or any other type of interfacing device in a wireless environment.

The present invention may be implemented in any type of wireless communication systems, such as a TDD, time division synchronous code division multiple access (TD-SCDMA), code division multiple access 2000 (CDMA2000) (EV-DO and EV-DV) or any other type of wireless communication system.

The features of the present invention may be incorporated into an IC or be configured in a circuit comprising a multitude of interconnecting components.

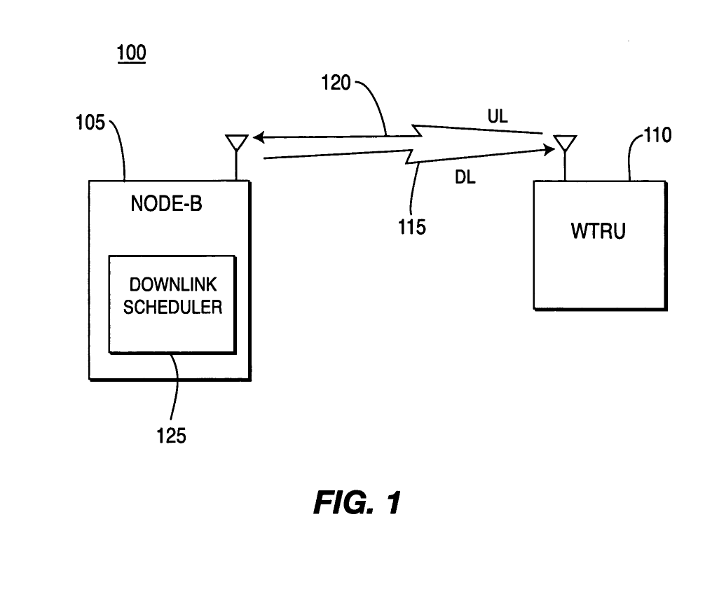

FIG. 1 shows a wireless communication system 100 including at least one Node-B 105 and at least one WTRU 110 which communicate via a downlink (DL) 115 and an uplink (UL) 120. The Node-B 105 includes a DL scheduler 125 which operates in accordance with the present invention.

When the Node-B 105 desires to send data to a WTRU 110, the Node-B 105 signals the WTRU 110 using a shared control channel (SCCH), such as a HS-SCCH, to instruct the WTRU 110 to monitor (i.e., listen), decode, and report a CQI based on the next DSCH, such as the HS-DSCH. To provide the DL scheduler 125 of the Node-B 105 with the needed channel quality information, the Node-B 105 may additionally signal, via a HS-SCCH carrying invalid TFRC information, at least one other WTRU to monitor, decode, and report a CQI based on one or more other HS-DSCH channels. However, the invalid TFRC information will inevitably lead to the negative acknowledgement (NACK) of data packets.

For example, the Node-B 105 sends a message to a particular WTRU 110 via the HS-SCCH indicating that a packet is coming on the next HS-DSCH transmission. The particular WTRU 105 will respond with a CQI report. The Node-B 105 performs better with receipt of a CQI report from one or more other WTRUs, so the Node-B 105 also sends a message to the other WTRUs via the HS-SCCH indicating that a packet is coming at the same time as the particular packet sent to the WTRU 110, but tells the other WTRUs the “wrong” TFRC for that transmission. Thus, the other WTRUs will also send a CQI report back to the Node-B 105 without having to use additional HS-DSCH resources, since the packet is used by the intended WTRU 110. In this manner, the other WTRUs will monitor a subset of the HS-DSCH transmission, possibly attempt to decode it, and most importantly report a CQI to the DL scheduler 125 of the Node-B 105.

In summary, at least one WTRU in a download state that is not currently being scheduled for HS-DSCH data by the Node-B 105 is instructed to monitor a least a portion of the HS-DSCH intended for a scheduled WTRU 110 so that it will generate and signal a CQI to Node-B 105. WTRUs in the download state may only be scheduled for HS-DSCH sporadically. Thus, the present invention provides a mechanism to keep the Node-B 105 informed of the channel quality for all WTRUs, not just the ones that have recently been scheduled for HS-DSCH. Since the non-scheduled WTRUs will always NACK or DTX, no malfunction of the WTRU will occur.

In such situations, the non-scheduled WTRUs may attempt to decode the HS-DSCH transmission. In doing so, it will waste power on data it has no chance of decoding because the correct TFRC has not been provided. The power wasted can be minimized by telling the WTRU (via the TFRC) that the packet is very small. Alternatively, the UE can recognize the TFRC as invalid and will not attempt to decode the data but, instead, will simply make an estimate of the signal-to-noise ratio (SIR) of the received HS-DSCH. Therefore, in accordance with the present invention, a WTRU only performs minimum processing required to estimate and report the CQI. Although a WTRU is also required to report a NACK, it need not attempt to decode the data in order to conclude that a cyclic redundancy check (CRC) check will fail.

The present invention provides a means for the Node-B 105 to obtain CQI reports from WTRUs that are not actively downloading, (i.e., they are not scheduled), so that the Node-B 105 can make informed scheduling decisions and selection of modulation and coding rates if and when one of these WTRUs is scheduled. The present invention provides a means to do this without having to use HS-DSCH resources. The HS-DSCH intended for other scheduled WTRUs are used by the non-scheduled WTRUs to make the CQI measurements.

In a preferred embodiment, the Node-B 105 signals a TFRC indicating a code rate greater than one and new data to the non-scheduled WTRU that the Node-B 105 desires to get a CQI from. Thus, the Node-B 105 provides the non-scheduled WTRU with a TFRC that will not permit the successful decoding of the corresponding HS-DSCH. By doing so, no additional signaling capacity is required while still being able to save WTRU power. The HS-DSCH is used by the scheduled WTRU 110, and thus it is not wasted. Power is saved because the non-scheduled WTRU can determine immediately that the HS-DSCH cannot be decoded and thus will not waste power trying to decode it, but will estimate CQI, which is a lower power consumption operation. Although not required, standardization of such signaling methods guarantees benefit from the power saving technique.

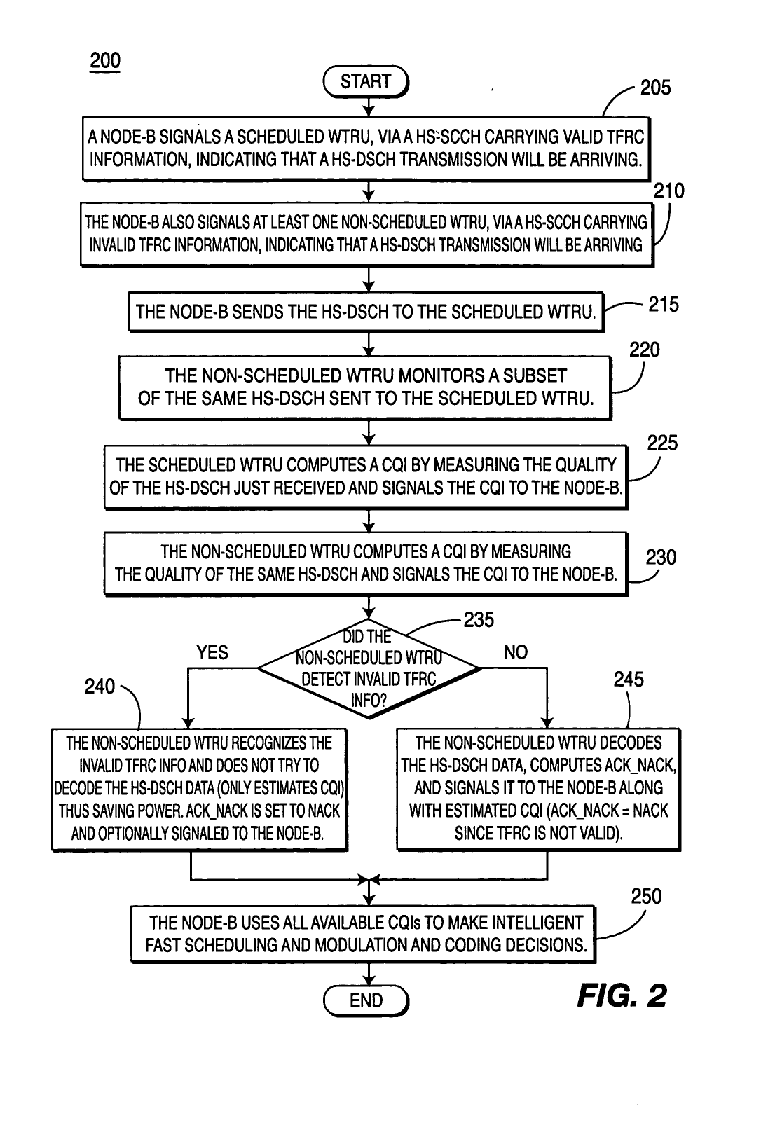

FIG. 2 is a flowchart of a process 200 including method steps for estimating channel quality in accordance with the present invention. In step 205, the Node-B 105 signals a scheduled WTRU 110, via a HS-SCCH carrying valid TFRC information, to indicate that a HS-DSCH transmission will be arriving. In step 210, the Node-B 105 also signals at least one non-scheduled WTRU, via a HS-SCCH carrying invalid TFRC information, to indicate that a HS-DSCH transmission will be arriving. In step 215, the Node-B 105 sends the HS-DSCH to the scheduled WTRU 110. In step 220, the non-scheduled WTRU monitors a subset of the same HS-DSCH sent to the scheduled WTRU 110. In step 225, the scheduled WTRU 110 computes a CQI by measuring the quality of the HS-DSCH just received, and signals the CQI to the Node-B 105. In step 230, the non-scheduled WTRU computes a CQI by measuring the quality of the same HS-DSCH, and signals the CQI to the Node-B 105.

As determined in step 235, if the non-scheduled WTRU detects invalid TFRC information, the non-scheduled WTRU recognizes the invalid TFRC information and does not try to decode the HS-DSCH data, (it only estimates CQI), thus saving power. The resulting ACK_NACK is set equal to NACK and is optionally signaled to the Node-B 105 (step 240).

As determined in step 235, if the non-scheduled WTRU does not detect invalid TFRC information in the HS-SCCH, the non-scheduled WTRU decodes the HS-DSCH data, computes ACK_NACK, and signals it to Node-B 105 along with estimated CQI (step 245). The ACK_NACK is set equal to NACK since the TFRC information is not valid. In step 250, the Node-B 105 uses all available CQIs to make intelligent fast scheduling and modulation and coding decisions.

The present invention solves two problems. First, it provides the DL scheduler 125 of the Node-B 105 with current CQI data for all WTRUs with the potential of being scheduled, thereby permitting the use of intelligent schedulers, e.g., maximum carrier-to-interference (C/I) or proportional fair schedulers. In order to use intelligent fast scheduling, (and to select optimal modulation and coding when a WTRU is scheduled), the Node-B 105 requires recent/current/up-to-date CQI data from all WTRUs that may be scheduled. This is not possible in conventional systems because CQI data is only available immediately after the WTRU receives a packet, and CQI data is valid for only a short time. This is a major flaw in TDD-HSDPA. The present invention obtains CQI data from a WTRU that has not recently received a packet in a way that does not require a change in the standard and does not require the use of additional HS-DSCH (radio) resources. Second, AMC performance is maintained as the period between HS-DSCH transmissions targeted to a specific WTRU increases due to infrequent scheduling and/or bursty traffic from higher layers. AMC also requires recent CQI to operate with peak performance, i.e., the channel quality needs to be known when the code rate and modulation are chosen.

While this invention has been particularly shown and described with reference to preferred embodiments, it will be understood by those skilled in the art that various changes in forms and details may be made therein without departing from the scope of the invention as described above.

1. In a wireless communication system including a Node-B and a plurality of wireless transmit/receive units (WTRUs), the Node-B including a downlink scheduler, a method for obtaining current channel quality estimates for the scheduler, the method comprising:
(a) the Node-B signaling a particular one of the WTRUs, via a shared control channel (SCCH) carrying valid transport format resource combination (TFRC) information, indicating that a downlink shared channel (DSCH) transmission will be arriving; and
(b) the Node-B signaling to at least one other one of the WTRUs, via a shared control channel (SCCH) carrying invalid transport format resource combination (TFRC) information, indicating that a DSCH transmission will be arriving.

2. The method of claim 1 further comprising:
(c) the Node-B transmitting the DSCH transmission to the particular WTRU;
(d) the other WTRU monitoring a subset of the DSCH transmission;
(e) each of the particular WTRU and the other WTRU determining a channel quality indicator (CQI) based on the quality of the DSCH transmission, and sending the CQIs to the Node-B; and
(f) the other WTRU determining a CQI without attempting to decode data included in the DSCH transmission when invalid TFRC information is detected.

3. The method of claim 2 wherein the downlink scheduler in the Node-B uses the CQIs to make intelligent fast scheduling and modulation and coding decisions.

4. The method of claim 2 wherein the other WTRU transmits a non-acknowledgement (NACK) message to the Node-B if invalid TFRC information is detected.

5. The method of claim 2 wherein the TFRC information is invalid if it does not carry information required to correctly decode data included in the DSCH transmission.

6. The method of claim 1 further comprising:
(c) the Node-B transmitting the DSCH transmission to the particular WTRU;
(d) the other WTRU monitoring a subset of the DSCH transmission;
(e) each of the particular WTRU and the other WTRU determining a channel quality indicator (CQI) based on the quality of the DSCH transmission, and sending the CQIs to the Node-B; and
(f) the other WTRU decoding data included in the DSCH transmission, performing a cyclic redundancy check (CRC) on the data, and signaling the results of the CRC along with the CQI to the Node-B when invalid TFRC information is not detected.

7. The method of claim 6 wherein the downlink scheduler in the Node-B uses the CQIs to make intelligent fast scheduling and modulation and coding decisions.

8. The method of claim 6 wherein the other WTRU transmits a non-acknowledgement (NACK) message to the Node-B if invalid TFRC information is detected.

9. The method of claim 6 wherein the TFRC information is invalid if it does not carry information required to correctly decode data included in the DSCH transmission.

10. A wireless communication system for obtaining current channel quality estimates, the system comprising:
(a) a Node-B including a downlink scheduler;
(b) a first wireless transmit/receive unit (WTRU); and
(c) a second WTRU, wherein:
(i) the Node-B signals the first WTRU via a shared control channel (SCCH) carrying valid transport format resource combination (TFRC) information, to indicate that a downlink shared channel (DSCH) transmission will be arriving; and
(ii) the Node-B signals the second WTRU, via a shared control channel (SCCH) carrying invalid transport format resource combination (TFRC) information, indicating that a DSCH transmission will be arriving.

11. The system of claim 10 wherein:
(iii) the Node-B transmits the DSCH transmission to the first WTRU;
(iv) the second WTRU monitors a subset of the DSCH transmission;
(v) each of the first and second WTRUs determine a channel quality indicator (CQI) based on the quality of the DSCH transmission, and send the CQIs to the Node-B; and
(vi) the second WTRU determines a CQI without attempting to decode data included in the DSCH transmission when invalid TFRC information is detected.

12. The system of claim 11 wherein the downlink scheduler in the Node-B uses the CQIs to make intelligent fast scheduling and modulation and coding decisions.

13. The system of claim 11 wherein the second WTRU transmits a non-acknowledgement (NACK) message to the Node-B if invalid TFRC information is detected.

14. The system of claim 11 wherein the TFRC information is invalid if it does not carry information required to correctly decode data included in the DSCH transmission.

15. The system of claim 10 wherein:
(iii) the Node-B transmits the DSCH transmission to the first WTRU;
(iv) the second WTRU monitors a subset of the DSCH transmission;
(v) each of the WTRUs determine a channel quality indicator (CQI) based on the quality of the DSCH transmission, and send the CQIs to the Node-B; and
(vi) the second WTRU decodes data included in the DSCH transmission, performs a cyclic redundancy check (CRC) on the data, and signals the results of the CRC along with the CQI to the Node-B when invalid TFRC information is not detected.

16. The system of claim 15 wherein the downlink scheduler in the Node-B uses the CQIs to make intelligent fast scheduling and modulation and coding decisions.

17. The system of claim 15 wherein the second WTRU transmits a non-acknowledgement (NACK) message to the Node-B if invalid TFRC information is detected.

18. The system of claim 15 wherein the TFRC information is invalid if it does not carry information required to correctly decode data included in the DSCH transmission.

19. A wireless transmit/receive unit (WTRU) comprising:
(a) means for receiving a signal, via a shared control channel (SCCH) carrying invalid transport format resource combination (TFRC) information, indicating that downlink shared channel (DSCH) will be arriving;
(b) means for determining a channel quality indicator (CQI) based on the DSCH;
(c) means for transmitting the CQI;
(d) means for detecting the invalid TFRC information; and
(e) means for determining a CQI without attempting to decode data included in the DSCH transmission when invalid TFRC information is detected.

20. The WTRU of claim 19 wherein the WTRU transmits a non-acknowledgement (NACK) message if invalid TFRC information is detected.

21. The WTRU of claim 19 wherein the TFRC is invalid if it does not carry information required to correctly decode data included in the DSCH transmission.

22. An integrated circuit (IC) comprising:
(a) means for receiving a signal, via a shared control channel (SCCH) carrying invalid transport format resource combination (TFRC) information, indicating that downlink shared channel (DSCH) will be arriving;
(b) means for determining a channel quality indicator (CQI) based on the DSCH;
(c) means for transmitting the CQI;
(d) means for detecting the invalid TFRC information; and
(e) means for determining a CQI without attempting to decode data included in the DSCH transmission when invalid TFRC information is detected.

23. The IC of claim 22 wherein the IC transmits a non-acknowledgement (NACK) message if invalid TFRC information is detected.

24. The IC of claim 22 wherein the TFRC information is invalid if it does not carry information required to correctly decode data included in the DSCH transmission.

25. The IC of claim 22 wherein the IC is incorporated into a wireless transmit/receive unit (WTRU).

26. A Node-B comprising:
(a) a downlink scheduler;
(b) means for signaling to a first device, via a shared control channel (SCCH) carrying valid transport format resource combination (TFRC) information, a message indicating that a downlink shared channel (DSCH) transmission will be arriving;
(c) means for signaling to second device, via a shared control channel (SCCH) carrying invalid transport format resource combination (TFRC) information, a message indicating that a DSCH transmission will be arriving; and
(d) means for receiving channel quality indicator (CQI) from the devices based on the DSCH transmission, wherein the second device does not attempt to decode data included in the DSCH transmission when invalid TFRC information is detected in the SCCH, and the Node-B uses the CQIs received from the first and second devices to make intelligent fast scheduling and modulation and coding decisions.

27. An integrated circuit (IC) comprising:
(a) a downlink scheduler;
(b) means for signaling to a first device, via a shared control channel (SCCH) carrying valid transport format resource combination (TFRC) information, a message indicating that a downlink shared channel (DSCH) transmission will be arriving;
(c) means for signaling to second device, via a shared control channel (SCCH) carrying invalid transport format resource combination (TFRC) information, a message indicating that a DSCH transmission will be arriving; and
(d) means for receiving channel quality indicator (CQI) from the devices based on the DSCH transmission, wherein the second device does not attempt to decode data included in the DSCH transmission when invalid TFRC information is detected in the SCCH, and the Node-B uses the CQIs received from the first and second devices to make intelligent fast scheduling and modulation and coding decisions.

28. The IC of claim 27 wherein the IC is incorporated into a Node-B.
